(19) United States
(12) Patent Application Publication
(10) Pub. No.: US 2017/0019022 A1
(43) Pub. Date: Jan. 19, 2017

(54) ELECTRICAL CONVERTER

(71) Applicants: Iain Alexander Anderson, Titirangi (NZ); Ho Cheong Lo, East Tamaki (NZ)

(72) Inventors: Iain Alexander Anderson, Titirangi (NZ); Ho Cheong Lo, East Tamaki (NZ)

(21) Appl. No.: 15/124,976

(22) PCT Filed: Mar. 10, 2015
(86) PCT No.: PCT/NZ2015/050023

§ 371 Date: Sep. 9, 2016

(30) Foreign Application Priority Data
Mar. 10, 2014 (NZ) 622108

(51) Int. Cl. H02M 3/156; H02N 2/18

(52) U.S. Cl. CPC H02M 3/156; H02N 2/181

(57) ABSTRACT

A self-powered converter and more particularly, though not exclusively, a step-down voltage converter requiring no external power supply, which is particularly suited to converting a high-voltage, low energy input from an intermittent DC power source to a low voltage DC output. There is provided an electrical converter for converting input power from an intermittent power source to a different voltage for a load, the converter comprising: a switched converter circuit coupled to an input for coupling to the power source and to an output for coupling to the load, the switched converter circuit arranged to convert power from the input to a different voltage and supply this to the output; a controller for controlling the switched converter circuit dependent on an input voltage at the input.

### TECHNICAL FIELD

This disclosure relates to an electrical converter and more particularly, though not exclusively, a step-down voltage converter requiring no external power supply, which is particularly suited to converting a high-voltage, low energy input from an intermittent DC power source to a low voltage DC output.

### BACKGROUND

Linear regulators are simple and inexpensive DC-DC converters. However, they can only be used as step-down converters and are highly inefficient as they dissipate excess electrical energy as heat.

Buck converters, boost converters, and/or buck-boost converters are all examples of a class of active converters commonly referred to as “switched-mode” power supplies (SMPS) which are actively controlled to regulate the output, and commonly provided in the form of an integrated circuit (IC) coupled with external discrete components including an inductor. Such converters are more efficient than linear regulators as they operate by temporarily storing and releasing energy. As shown diagrammatically in FIG. 1, these active converters 10 typically comprise a sensor 21, controller 12, and driver electronics 13 which increase the size, cost, and complexity of the circuit. Also, a low voltage (e.g. 3.3V or 5V) power source 14 is required to power the converter. This power may be supplied to the converter IC at times when there is no input power requiring conversion, leading to standby power losses. Other converters of the prior art including fly-back, forward, and H-bridge converters have similar requirements.

While such DC-DC converters are suitable for many applications requiring DC voltage conversion, there are other applications in which both the inefficiency of the linear regulator and the active control requirement of SMPS may be undesirable. Reasons include, but are not limited to, cost, form factor, complexity, efficiency, and/or availability of technology,

The need for a separate low-voltage power source such as a battery, standby power losses, and/or inefficient conversion are particularly problematic or undesirable in a converter intended for use with high-voltage, limited-energy, low-power sources. The linear regulators of the prior art are too inefficient to obtain any usable power from such sources, while the known switched-mode power supplies require high-voltage components which are relatively large and expensive, and high-voltage sensors which often have a significant amount of leakage current and may dissipate a significant proportion of the energy generated. They also consume power during periods when there is no input power for conversion.

International Patent Publication No, WO 2013/055238 discloses a simple converter comprising a passive switching circuit adapted to passively couple the input to the output when the input exceeds a first threshold, and decouple the input from the output when the input falls below a second threshold. The passive switching circuit may comprise a spark gap, thyristor and avalanche diode, breakover diode, discharge tube, or a thyristor operated as breakover diodes, for example. The input voltage directly controls the passive switch to couple the input power source to the converter without an intermediary sensor, driver, or controller. Accordingly, the converter has no fixed energy costs associated with its functioning (attributed to losses due to leakage currents and resistance of non-ideal components in the switching circuit, for example), and is self- or parasitically-powered using a small fraction of the power directly from the power source as the conversion process is in operation. The passive converter thus does not require a secondary power source or sensing/control signals (aside from a passively-generated control signal In at least one embodiment).

However, the passive converter disclosed in WO 2013/055238 suffers from the disadvantages of relatively low efficiency and only limited regulation of the output voltage/current.

Object

It is therefore an object of the embodiments of the invention to provide a converter which overcomes or at least ameliorates one or more disadvantages of known arrangements, or alternatively to at least provide the public with a useful choice.

Further objects will become apparent from the following description.

### SUMMARY OF INVENTION

In a first aspect there is provided an electrical converter circuit comprising:
an input for receiving input power from a power source;
an output for supplying converted power to a load;
an actively-switched converter sub-circuit coupled to the input and the output for selectively converting the input power to the converted power; and
a control sub-circuit for controlling the actively-switched converter sub-circuit, the control sub-circuit comprising a passively-switched converter sub-circuit and a pulse generator coupled to the actively-switched converter sub-circuit.

In an embodiment the passively-switched converter is coupled to the input and converts a portion of the input power for supply to the pulse generator. Alternatively, the electrical converter circuit may further comprise a generator for selectively supplying power to the passively-switched converter sub-circuit.

In an embodiment the actively-switched converter sub-circuit comprises a switch, an inductor, and a diode. More particularly, the actively switched converter sub-circuit preferably comprises a switch, an inductor, and a diode in a buck-converter configuration.

In an embodiment the pulse generator is coupled to a gate of the switch to control operation thereof.

In an embodiment the passively-switched converter sub-circuit comprises a passive switching sub-circuit coupled to a transformer.

In an embodiment the passive switching sub-circuit comprises one of a spark gap, breakover diode, discharge tube, thyristor with floating gate terminals used as a breakover diode.

In an embodiment the passive switching sub-circuit conducts when an input to the control sub-circuit exceeds a first threshold, and ceases conducting when the input to the control sub-circuit falls below a second threshold.

In an embodiment the power source comprises an intermittent or oscillating DC power source. More particularly, the power source comprises a dielectric elastomer generator or a piezoelectric generator.

In an embodiment the pulse generator generates a pulse wave when powered by the passively-switched converter sub-circuit. The pulse wave may have a predetermined fixed or adjustable duty cycle.

In an embodiment the control sub-circuit provides open-loop control of the actively-switched converter sub-circuit.

Alternatively, the electrical converter circuit may further comprise an output sensor coupled to the control circuit, and the control circuit may provide closed-loop feedback control of the actively-switched converter sub-circuit.

In another aspect there is provided an electrical converter for converting input power from an intermittent power source to a different voltage for a load, the converter comprising: a switched converter circuit coupled to an input for coupling to the power source and to an output for coupling to the load, the switched converter circuit arranged to convert power from the input voltage to an output voltage for the load; a controller for controlling the switched converter circuit dependent on an input voltage at the input.

In an embodiment the controller is arranged to operate the switched converter circuit when the input voltage exceeds a predetermined threshold. In this way the switched converter circuit may only be used when there is power available to be converted. Thus the switched converter circuit does not consume power when not in use, thereby limiting standby power consumption. At the same time when used, the converter provides high efficiency power conversion when there is power available to convert. This is advantageous when used with intermittent power sources such as shoe heel generators where useful power is typically only provided for a small fraction of time. However the embodiment is also useful in other applications.

In an embodiment the controller comprises a trigger circuit coupled to a driver circuit , the trigger circuit arranged to control the driver circuit responsive to the input voltage, and the driver circuit arranged to control switching of a switch of the converter circuit.

In an embodiment the trigger circuit comprises a passive switch arranged to conduct when the input voltage exceeds a predetermined threshold. The trigger circuit may comprise an inductive element connected to the passive switch, the passive switch being selected from one or more of the following: spark gap; break-over diode; discharge tube; thyristor with floating gate terminals.

In an embodiment the driver circuit comprises a pulse generator. This will be configured to generate a pulse frequency and duty cycle according to well known parameters for configuring switched converter circuits, as would be understood by those skilled in the art. Example switched converter circuits include: buck converter; boost converter; buck-boost converter.

There is also provided a power supply comprising an intermittent power source coupled to an electrical converter as herein defined. As noted above this may be a shoe heel generator, wind generator, body movement generator and the like. This may be implemented as a deformable capacitor and the power supply further comprises a priming circuit coupled to the deformable capacitor and arranged to supply a priming voltage to the power source. An example deformable capacitor is a dielectric elastomer, such an arrangement forming a dielectric elastomer generator (DEG).

There is also provided an electrical power harvesting circuit for an intermittent power source; the circuit comprising: a priming circuit arranged to supply a priming voltage to the power source; a converter as herein defined for coupling to the power source and arranged to convert input power from the power source to a different voltage for a load.

Further aspects of the invention, which should be considered in all its novel aspects, will become apparent from the following description.

### DRAWING DESCRIPTION

A number of embodiments of the invention will now be described by way of example with reference to the drawings in which:

FIG. 1 is a block diagram of an active converter, such as a switched-mode power supply, according to the prior art;

FIG. 2 is a block diagram of a self-powered converter according to an embodiment of the present invention;

FIG. 3 is a schematic of an example passively-switched converter forming part of the self-powered converter according to an embodiment of the present invention; and

FIG. 4 is a schematic of an example circuit comprising a self-powered converter according to an embodiment of the present invention

FIG. 5 illustrates a dielectric elastomer generator cycle;

FIG. 6 illustrates a priming circuit;

FIG. 7 illustrates a priming circuit according to a second embodiment;

FIGS. 8 and 9 are equivalent circuits of FIG. 7;

FIG. 10 is a general self-priming circuit according to another embodiment;

FIG. 11 shows voltage output from a DEG; and

FIG. 12 is an example trigger circuit according to an embodiment.

### DETAILED DESCRIPTION OF THE DRAWINGS

Throughout the description like reference numerals will be used to refer to like features in different embodiments. Unless the context clearly requires otherwise, the terms “high voltage”, “low voltage” and the like throughout the description and claims are used in the relative sense, and are not intended as limiting the respective voltages to any particular range.

Embodiments of the present invention provide a converter which is particularly suited for use as a voltage converter coupled to a limited-energy, low-power DC source. A limited-energy power source in this context is a power source which does not supply power continuously. For the purposes of the following description, a limited-energy source may be thought of as being equivalent to a small capacitor with a small amount of stored energy, where the voltage will drop rapidly if energy is drawn from it. That is, power is available only intermittently due to the cyclical nature of a generation process and/or intermittent or unpredictable application of mechanical energy, for example.

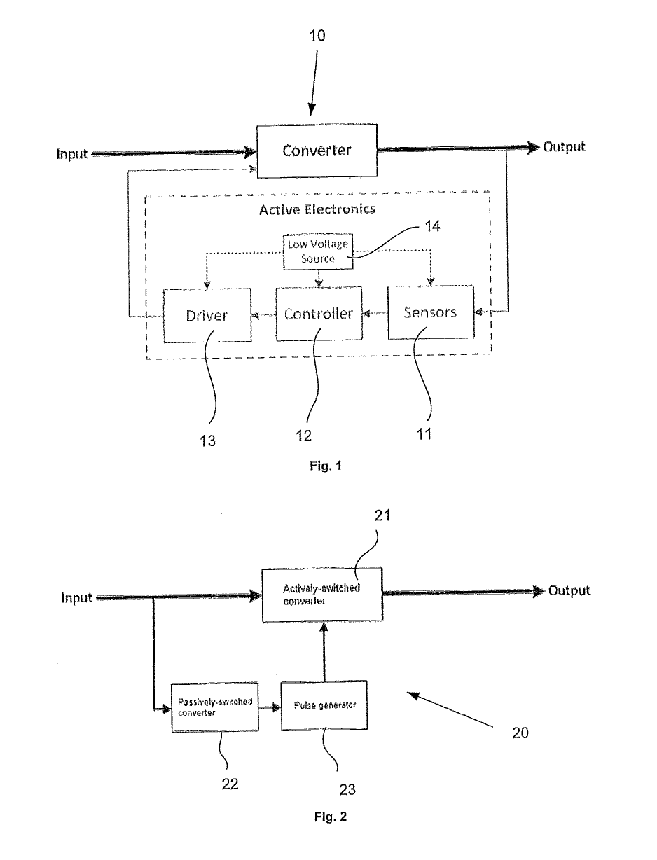

Referring first to FIG. 2, there is shown a block diagram of a converter 20 according to an embodiment. The converter 20 comprises actively-switched converter 21 which receives an input, converts the input to another voltage or current, and supplies the converted input to an output. The actively-switched converter 22 may comprise a switch S, inductor L, and diode D in a buck converter configuration as shown in FIG. 4, for example. However, the actively-switched converter 21 is not limited to those particular components or configuration, and the sub-circuit may alternatively comprise a boost or buck-boost converter, for example.

In known buck, boost, buck-boost or similar converters, operation of the switch S would ordinarily be controlled on the basis of feedback from the output of the converter as shown in FIG. 1, using a proportional-integral-derivative (PID) or similar control scheme. The controller thus requires a separate low-voltage power supply to determine the appropriate duty cycle to regulate the output.

According to the present embodiment, however, operation of the actively-switched converter 21 is controlled by the passively-switched converter 22 and pulse generator 23.

The passively-switched converter 22 is preferably coupled to the same input as the actively-switched converter 21, and converts the input to an appropriate voltage for the pulse generator. The passively-switched converter is arranged to trigger operation of the actively switched converter (or switched converter circuit) when an input voltage exceeds a predetermined threshold. Examples of such passively-switched converters or trigger circuits are described in more detail below. Additional example trigger circuits are also described in WO 2013/055238.

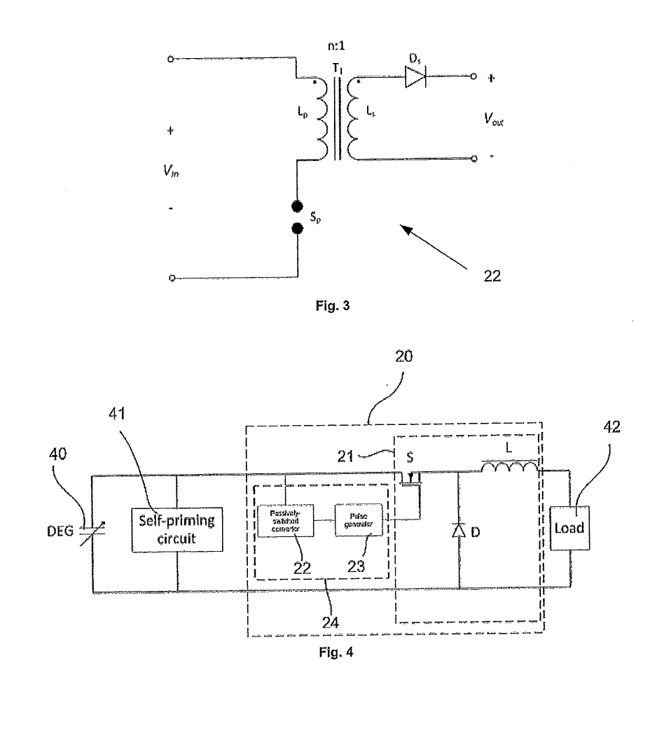

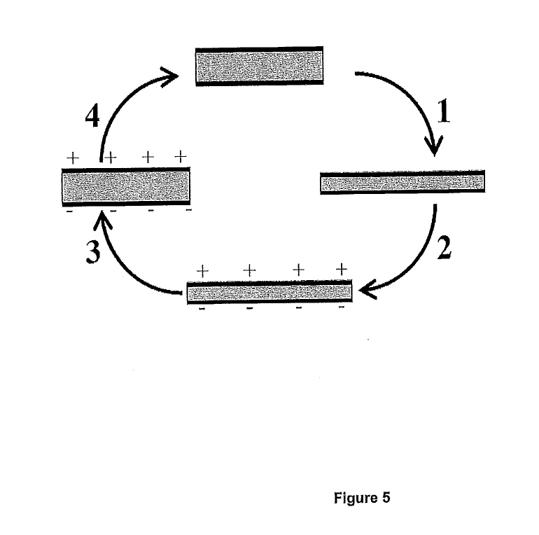

An example schematic of a passively-switched converter or trigger circuit 22 is shown FIG. 3. In this example, the passively-switched converter 22 comprises a transformer T₁ having a primary winding Lₚ coupled to a passive switching circuit. In this embodiment, the passive switching circuit comprises the spark gap S_{P} in series with the primary winding Lₚ. The passive switching circuit may alternatively comprise a breakover diode, discharge tube, thyristor with floating gate terminals used as breakover diodes, and the like.

The transformer T₁ preferably has a secondary winding coupled to the output via diode Dₛ. Additional circuitry (not shown) such as a full-wave rectification diode network could alternatively be used to couple the secondary winding to the output to deliver current to the load in the event the secondary winding becomes negatively polarised, as will be apparent to those skilled in the art.

Initially, with only a small voltage Vᵢₙ on the input, the spark gap S_{P} operates as an open circuit preventing current flowing through the primary winding Lₚ. When the input voltage Vᵢₙ exceeds a first threshold (in this case the breakdown voltage of the spark gap, e.g. approximately 1 kV), the spark gap S_{P} will break down and conduct current. That is, ionized air creates a conductive path across the gap which drastically reduces the electrical resistance of the gap.

Once the spark gap S_{P} breaks down, a low-resistance conducting path is formed and the input is coupled to the primary winding Lₚ.

While current is conducted through the spark gap S_{P}, the input voltage Vᵢₙ is conducted by the primary winding Lₚ. This induces a positive voltage in the secondary winding Lₛ which is supplied to the output, represented by Vₒᵤₜ. The output voltage will depend largely upon the first threshold (e.g. the breakdown voltage of the spark gap S_{P}) and the turns ratio n of the transformer T₁. The breakdown voltage of the spark gap depends, for example, upon the gap (i.e. distance), the gas between the electrodes, and the geometry of the electrodes.

The spark gap S_{P} will cease conducting once the input falls below a second threshold; in this case, the current through the spark gap falling below the holding current of the spark gap. Once transformer T₁ has released all of its stored energy, current flow through the primary winding Lₚ will cease and the spark gap S_{P} will enter a non-conducting, open circuit state.

Operation of the passively-switched converter or trigger circuit 22 is thus triggered by the input voltage exceeding the first threshold, and provides limited control of the output voltage of the converter 20. The passive switching circuit is thus preferably selected or designed to have a first threshold appropriate for the intended use of the converter.

Referring again to FIG. 2, the output of the passively-switched converter 22 is supplied to power the pulse generator 23, which generates a pulse train of a predetermined or selected duty cycle which is supplied to the actively-switched converter 21 to control operation thereof, or more specifically to the gate of switch S to control conduction thereof between the source and drain. The switch S is preferably a fast transistor which is turned on for a relatively short time to avoid saturation limit of the inductor L.

The duty cycle of the pulse generator 23 affects the voltage and current of the output. It may be either fixed or adjustable (using a potentiometer, for example) to allow for adjustment of the converter. Pulse generators suitable for driving the switching of a switched converter circuit will be well known to those skilled in the art, and are not further described here. The switching signals or pulses may be adjusted by frequency and duration in order to generate a desired output voltage waveform. Any suitable pulse generator circuit may be used.

Operation of the converter of the present embodiment will be described below with reference to an example application in a dielectric elastomer generator (DEG)-based energy harvesting system.

Dielectric elastomer generators (DEGs) are an example of a high-voltage, limited energy, low-power source. They are a type of energy harvester or generator capable of converting mechanical energy to electrical energy. A DEG comprises a thin (in relation to its planar area) and resilient dielectric elastomer membrane with compliant electrodes on opposing sides. In effect, the DEG is a variable capacitor, and its capacitance changes with mechanical strain (i.e. deformation of the membrane). The DEG generates electrical energy by increasing the electric potential energy stored in it. Mechanical energy is applied to the DEG by stretching it. This results in a planar expansion of the electrodes and an orthogonal compression of the membrane, leading to an increased capacitance. Electrical energy is then input to the DEG by charging or priming from an electric power source so that opposing electrodes become oppositely charged. Relaxing the DEG will convert the mechanical energy into electrical energy by forcing apart the opposite charges (+and −) on opposing electrodes, and forcing the like charges on each electrode closer together due to the planar contraction thereof. The electrical energy is extracted and the cycle repeats. DEG are generally operated at high voltages (typically a few kilovolts) to increase power generation

A DEG is essentially a variable capacitor power generator device, To generate electrical power, the electrodes of a DEG are first charged to a bias or priming voltage and then deformed so that the opposite charges are separated and like charges are forced closer to each other. This deformation adds electrical energy to the charges, increasing the voltage across the electrodes.

An energy reservoir or capacitor bank may be used to supply the bias voltage. Methods of achieving this include permanently connecting the DEG to a battery to supply the bias voltage. The DEG effectively increases the amount of energy the battery can supply. The battery needs to be replaced or recharged after it has been drained of energy. In an alternative arrangement the bias or priming voltage may be supplied by a capacitor bank and when the DEG generates power, charge is returned to the capacitor bank. In a theoretical system with no losses, the total amount of charge in the system remains constant and it is transferred to the DEG which increases its energy and then returns it back to the charge reservoir.

The converter 10 of the present embodiment forms part of the DEG-based energy harvesting system shown by way of example in the schematic of FIG. 4. The system comprises a DEG 40, a self-priming circuit 41 coupled to the DEG 40, the self-powered converter 20 with inputs coupled to both the DEG 40 and self-priming circuit 41, and a load 42 coupled to the output of the converter 20. The passively-switched converter or trigger circuit 22 and a driver circuit such as a pulse generator 23 together form a controller or control circuit 24 which controls the actively-switched converter 21 of converter 20. Although not shown, the system preferably further comprises a power source to initially prime the DEG. This power source may comprise another energy harvesting technology or an energy storage device, for example.

The self-priming circuit 41 may comprise a plurality of capacitors and a plurality of diodes arranged such that at least two of the plurality of capacitors are effectively in parallel with each other when current is flows in a first direction and effectively in series when current flows in a second direction, whereby the circuit has a capacitance when current flows in the first direction greater than the capacitance of the circuit when current flows in the second direction, and current switches from the first direction to the second direction when a voltage across the electrostatic generator increases by less than 100%.

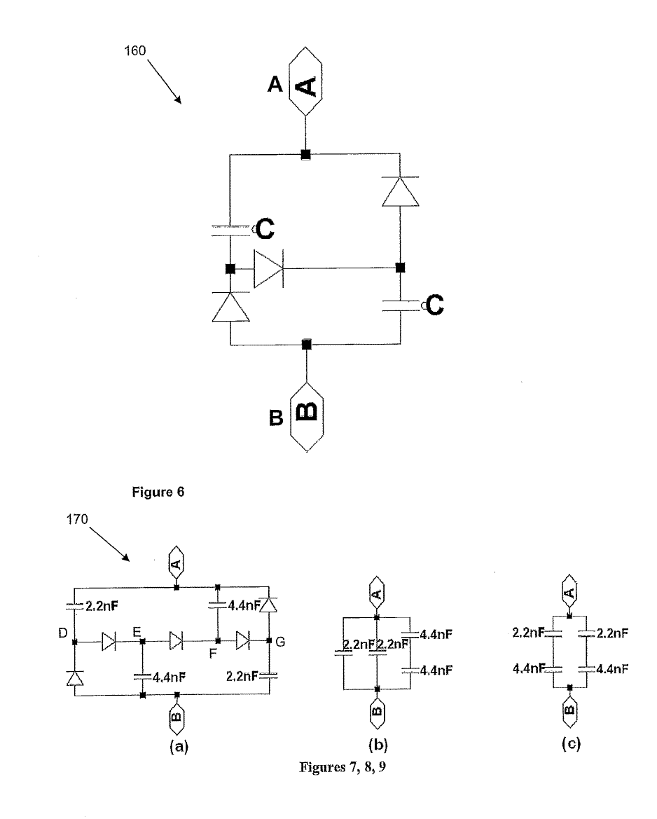

FIG. 6 is a circuit diagram of a self priming circuit 160 according to an embodiment. Self priming circuit 160 includes two capacitors of capacitance C and three diodes arranged as illustrated. When a capacitor bank supplies a priming voltage to a DEG, current flows from node B to node A. When current flows in this direction, because of the diodes the capacitors are effectively arranged in parallel as far as current flow is concerned, meaning the energy is in a high charge, low voltage form. To transfer energy back from the DEG to the capacitor bank, current flows in the direction of node A to node B. When current flows in this direction, the arrangement of the diodes means the capacitors are effectively in series, meaning the energy is in a high voltage, low charge form. However, one characteristic of this circuit is that the proportional change in voltage produced by the DEG needs to be higher than the proportional change in the voltage across the capacitor bank when it changes from the parallel state to the series state. In the embodiment illustrated in FIG. 6 with the two capacitors having the same capacitance, the voltage needs to double for the system to self prime.

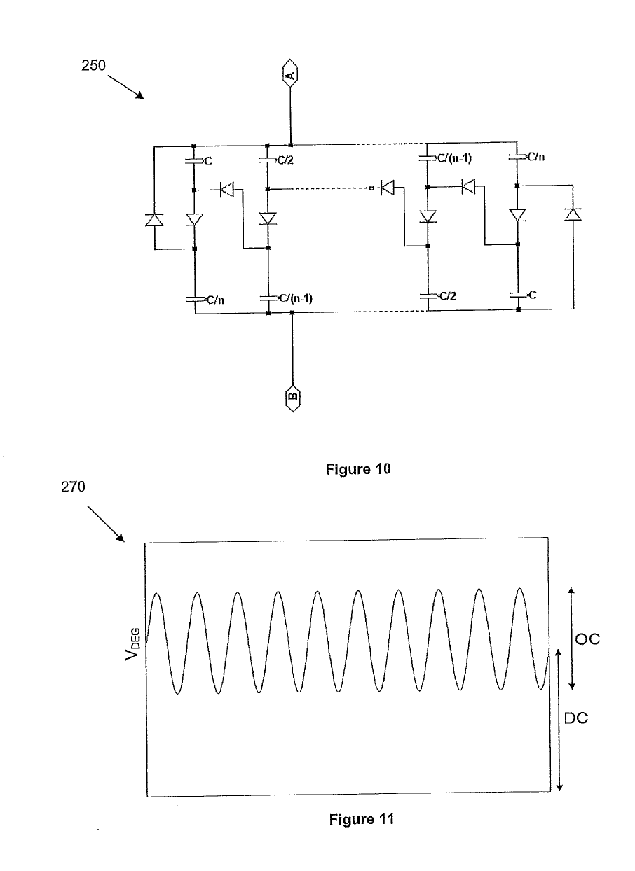

FIG. 7 is a circuit diagram of a self priming circuit 170 according to another embodiment. The circuit again contains a plurality of capacitors and a plurality of diodes in the arrangement shown and works in similar fashion to that described above in relation to FIG. 6. When the capacitor bank is supplying the DEG, current flows from node B to node A, and in this case the equivalent circuit is shown in FIG. 8. When energy is transferred back to the capacitor bank and current flows from node A to node B, the equivalent circuit is shown in FIG. 9.

FIG. 10 is a circuit diagram of a general self priming circuit 250 according to an embodiment of the invention. The required percentage voltage swing %ΔV_{DEG}_{_}ₘᵢₙ can be reduced by increasing the number of units in the capacitor bank according to the equation:

$$\% Δ {V}_{DEG\_min} = \frac{100}{n} .$$

Self priming circuit 250 may be used with a DEG or transformer such that the circuit is optimised or at least selected according to the required application of the circuit. In this embodiment, control circuitry can be included to adjust the structure of the self priming circuit such that the number of capacitors included in the self priming circuit can be varied, for example, by switching capacitors in or out of the circuit.

Self priming circuits as described herein advantageously allow a DEG to run without being constantly connected to a power source. Also, DEGs have been able to be self primed from 2V up to the kV range, thus overcoming the need for expensive DC-DC converters required with conventional dielectric elastomer circuitry.

FIG. 11 is a graph 270 of the voltage output from a DEG. The output has an oscillating component, labelled ‘OC’, and a DC offset component, labelled ‘DC’. The amplitude of the oscillating component OC is dependent on how much geometric change the DEG undergoes and the magnitude of the DC component. The DC component is dependent on how much energy is stored in the associated self priming circuit. The DC component can be boosted by increasing the frequency and/or magnitude of the DEG deformations or by decreasing the energy drawn by the load.

Further priming circuit examples are described in WO 2011/005123,

Referring back to FIG. 4, in use, the DEG 40 is deformed so that its capacitance increases, but no charge flows from the self-priming circuit to the DEG because the voltage across the DEG 40 is initially greater than that of the self-priming circuit 41. As the DEG continues to deform, the voltage across the DEG decreases as the capacitance increases, and current flows from the self-priming circuit to the DEG when the voltage across the self-priming circuit exceeds that of the DEG. The DEG relaxes upon removal of the deformation force and its capacitance decreases, but no charge flows from the DEG to the self-priming circuit because the voltage across the DEG is initially less than that of the self-priming circuit. As the relaxation of the DEG continues, but the voltage of the DEG begins to exceed that of the self-priming circuit, and current flows from the DEG to the self-priming circuit.

The voltage across the DEG 40 and self-priming circuit 41 increases with every oscillation (assuming an oscillatory mechanical deformation of the DEG 40). When the voltage reaches a first threshold (e.g. a breakdown voltage of the breakover diode or other passive switching circuit of the passively-switched converter 22, which might be approximately 900V for example), the passively-switched converter turns on. A small amount of the high voltage energy is drawn and converted to a lower voltage, albeit relatively inefficiently. This converted voltage is supplied to the pulse generator 23, which switches the transistor S on for a desired length of time. This drives the actively-switched converter which more efficiently converts a portion of the high voltage energy stored by the DEG 40 and self-priming circuit 41 into a lower voltage which is supplied to the load 42.

The output voltages of the passively-switched converter 22 and actively-switched converter 21 may be either the same or dissimilar.

The converter of the present embodiment is thus both self-powered, in that power for the control circuit is drawn from the high voltage input, and self-triggered, in that power is only supplied to the control circuit when voltage conversion is required. In an energy harvesting system such as the above example which may be embedded in footwear as a heel-strike generator, voltage conversion may be required for less than 0.1% of the time.

Although embodiments have been described by way of example and with reference to the figures, it is to be understood that modifications or improvements may be made thereto without departing from the scope of the claimed subject matter. This may include the parts, elements and features referred to or indicated in the specification of the application, individually or collectively, in any or all combinations of two or more of said parts, elements or features. Furthermore, where reference has been made to specific components or integers having known equivalents, then such equivalents are herein incorporated as if individually set forth.

In particular, embodiments are not limited to use with dielectric elastomer generators. The properties of the embodiments which make them suited to that application may be similarly useful in combination with other generator technologies for example, and in particular those which harvest energy from intermittent sources.

In other embodiments, the passively-switched converter 22 may be powered by a separate generator. The separate generator may be based on a different technology to the main DEG generator, such as a piezoelectric generator (or vice versa) for example. The piezoelectric generator may be configured to generate power for the control circuit when it is needed, with the DEG generator generating more power for conversion. The converter 20 is self-powered in the sense that the converter 20 comprises the additional generator and electrical energy is generated from mechanical energy as required, rather than requiring an energy storage device such as a battery or external power supply.

In yet other embodiments, the converter 20 may be adapted to a closed-loop control scheme with the addition of an output voltage sensor to provide better regulation of the output voltage, at the cost of increased power consumption.

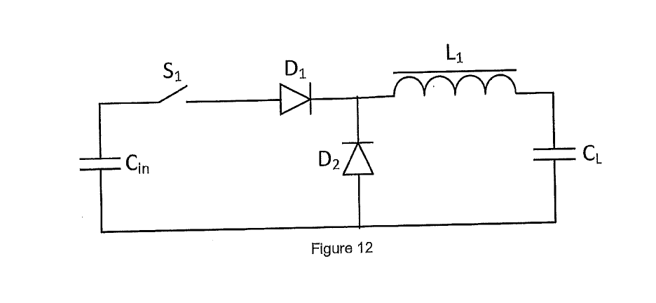

Yet another alternative trigger circuit is shown in FIG. 12. This incorporates a conversion circuit based on an inductor rather than a transformer. The passive switching element S₁ (represented in this schematic by a standard mechanical switch symbol, but which may comprise any of the aforementioned or equivalent passive switches) couples the input Cᵢₙ to the inductor L₁ when the input voltage reaches a first threshold. Energy is stored in inductor L₁, which is released to the output C_{L} at the desired voltage. Reverse blocking diode D₁ prevents energy being returned to the input Cᵢₙ from the converter circuit. Freewheeling diode D₂ prevents a large negative voltage spike appearing across inductor L₁ when the passive switch ceases to conduct.

Although some embodiments have described operation of the trigger circuit or passive switched converter as causing operation of the active or switched converter circuit when an input voltage exceeds a predetermined threshold, such operation may be more generally dependent on the input voltage. For example a range of voltages may cause activation of the switched converter circuit, or different threshold voltages depending on preceding conditions.

From the foregoing it will be seen that a converter is provided which avoids at least some of the problems of the switched-mode power supplies of the prior art, in that no separate low voltage power supply is necessarily required to power the control circuit, and the control circuit suffers no standby power losses. It can also be seen that the circuit provides open-loop control without the high-voltage sensors (and associated cost and power losses) required for the closed-loop control of the prior art SMPS converters. On the other hand, the present invention offers significantly better efficiency than the linear regulators of the prior art.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Any discussion of the prior art throughout the specification should in no way be considered as an admission that such prior art is widely known or forms part of common general knowledge in the field.

1. An electrical converter for converting input power from an intermittent power source to a different voltage for a load, the converter comprising:
a switched converter circuit coupled to an input for coupling to the power source and to an output for coupling to the load, the switched converter circuit arranged to convert power from the input voltage to an output voltage for the load; and
a controller for controlling the switched converter circuit dependent on an input voltage at the input.

2. The converter according to claim 1, wherein the controller is arranged to operate the switched converter circuit when the input voltage exceeds a predetermined threshold.

3. The converter according to claim 1, wherein the controller comprises a trigger circuit coupled to a driver circuit, the trigger circuit arranged to control the driver circuit responsive to the input voltage, and the driver circuit arranged to control switching of a switch of the converter circuit.

4. The converter according to claim 3, wherein the trigger circuit comprises a passive switch arranged to conduct when the input voltage exceeds a predetermined threshold.

5. The converter according to claim 4, wherein the trigger circuit comprises an inductive element connected to the passive switch, the passive switch being selected from one or more of the following: spark gap; break-over diode; discharge tube; thyristor with floating gate terminals.

6. The converter according to claim 3, wherein the driver circuit comprises a pulse generator.

7. The converter according to claim 1, wherein the switched converter circuit comprises one of the following: buck converter; boost converter; buck-boost converter.

8. A power supply comprising an intermittent power source coupled to the electrical converter of claim 1.

9. The power supply of claim 8, wherein the intermittent power source is a deformable capacitor and the power supply further comprises a priming circuit coupled to the deformable capacitor and arranged to supply a priming voltage to the power source.

10. The power supply of claim 9, wherein the deformable capacitor is a dielectric elastomer.

11. An electrical power harvesting circuit for an intermittent power source; the circuit comprising:
a priming circuit arranged to supply a priming voltage to the power source;
a converter according to claim 1 for coupling to the power source and arranged to convert input power from the power source to a different voltage for a load.
